(19) United States
(12) Patent Application Publication
(10) Pub. No.: US 2007/0059540 A1
(43) Pub. Date: Mar. 15, 2007

(54) Method of producing optical compensation film

(75) Inventors: Kuang-Rong Lee, Hsinchu City (TW); Tan-Ching Wang, Taoyuan County (TW); Ying-Da Tzeng, Taipei City (TW); Yu-Hwey Chuang, Taichung City (TW)

Correspondence Address: BUCKNAM AND ARCHER, 1077 NORTHERN BOULEVARD, ROSLYN, NY, 11576, US

(73) Assignee: OPTIMAX TECHNOLOGY CORPORATION

(21) Appl. No.: 11/365,076

(22) Filed: Mar. 1, 2006

(30) Foreign Application Priority Data
Sep. 15, 2005 (TW) 094131810

(51) Int. Cl. B05D 5/06; B32B 27/34

(52) U.S. Cl. 428/474.4; 427/162; 428/1.1

(57) ABSTRACT

The present invention provides a cost-efficient, easy-processed producing method, instead of utilizing complicated steps of stretching and precisely controlling stretching ratio and direction in conventional technology, to obtain a PI optical compensation negative C plate of biphenyl ring structure without fluorine by means of coating, and an optical compensation film of PI film-comprising negative birefringent C plate useful as viewing angle compensation film for TFT-LCDs.

### FIELD OF THE INVENTION

The present invention is directed to an optical compensation film, and a method of producing optical compensation film. Particularly, The present invention is directed to a cost-efficient, easy-processed producing method to obtain a PI optical compensation negative C plate of biphenyl ring structure without fluorine by means of coating, and an optical compensation film of PI film-comprising negative birefringent C plate useful as viewing angle compensation film for TFT-LCDs.

### DESCRIPTION OF THE RELATED PRIOR ART

Liquid crystal displays (LCDs) exhibit light and dark effects by utilizing the features of liquid crystal molecular spin-polarization direction and birefringence, and the displaying qualities vary depending on the viewer angle. With the development of large-screen liquid crystal displays, it becomes important to widen viewing angles.

Many new processes for improving viewing angles have been proposed in recent years, e.g. (1) process of optical compensation film; (2) process of Multi-domain Vertical Alignment (MVA); (3) process of In Plane Switching (IPS), etc. The above processes for widening viewing angles of liquid crystal displays (2) and (3) are not widely used since they involve complicated methods for producing liquid crystal cell, further, the addition of optical compensation film is necessary for them to obtain better viewing angles. On the other hand, process of optical compensation film (1) is generally used in improving viewing angles of LCD, since it is easy to be done without modifying conventional LCD manufacturing processes only by the addition of optical compensation film. Therefore, the current liquid crystal displays of wide viewing angle are produced mainly based on “the process of optical compensation film”.

Generally speaking, conventional optical compensation films are categorized according to optical axis distribution into (a) C-plate; (b) optical compensation film with rotation structure; (c) optical compensation film with dual optical properties; and (d) discotic liquid crystal optical compensation film, etc. usually, there are two types of optical compensation film, i.e. positive and negative. Conventionally, both types are used by adhering to liquid crystal panel. Positive type optical compensation film is made of rod-shape molecules or by stretching high polymers like polystyrene (PS), poly vinyl chloride (PVC) and poly carbonate (PC), which are utilized mainly to lower operation voltage of liquid crystal panel. On the other hand, negative type optical compensation film is mainly made of polyamide (PI) or discotic liquid crystals, which are utilized mainly to improve viewing angles of displays.

Typically, C-plate optical compensation film is of optical character of nx=ny>nz, as disclosed in Harris, “Polymers”, 37, pp. 5321 and after, 1996. As this C-plate optical compensation film is characterized in nx=ny, displaying qualities of liquid crystal displays in vertical direction are not effected. Further, as it is characterized in having a negative birefringence equal to positive birefringence of rod-shape liquid crystal with opposite sign (Δn=nz−nx<0), it is suitable to compensate light leaking problem arisen by liquid crystal molecules aligned vertical to substrate in liquid crystal elements, to enhance viewing angles of displays of TN and vertical alignment modes.

Conventional phase differential films are mostly obtained by stretching high polymer films like TAC, PC, COP (e.g. Japanese Patent Application Hei 3-33719, Hei 3-24502, Hei 4-194820, US Patent 2004-0046272, Japanese Patent Application Hei 15-255102, Hei 13-215332, Hei 10-045917, Hei 1-132625, Hei 1-132626, Hei 2-133413, Hei 63-218726, Sho 61-115912, etc.) For polymer materials usable as negative C-plate, polyamide with planar phenyl ring on main chain was disclosed (e.g. U.S. patents U.S. Pat. No. 5,344,916, U.S. Pat. No. 5,395,918, U.S. Pat. No. 5,480,964, U.S. Pat. No. 5,580,950, U.S. Pat. No. 6,074,709, U.S. Pat. No. 6,303,743, Japanese Patent Application Hei 8-511812, WO2003/071319, WO2004/011970, WO2004/028110, Japanese Patent 2003/009568). The features of negative C-plate are applicable to LCDs of STN, TN, IPS, VA, OCB, and ASM modes to enhance viewing angles.

Among the above materials, cellulose acetate film is of problems in shape stability and adhesion due to high moisture absorption, and durability is poor due to higher content of low molecular weight phase retardation agent compounds, compared to polyolefins. In addition, resins with this aromatic phase retardation agent compounds is of larger wavelength distribution due to absorption of visible rays.

Further, discotic liquid crystal can not be used alone, and a coating layer with maximum thickness precisely applied on a transparent substrate is required. In addition to the cost of precisely application process, the higher birefringence of discotic liquid crystal causes larger phase difference due to the small difference between thickness of coating layers. Besides, it is possible to cause optical defeats by contaminants like dusts remaining on surfaces of applied films or in discotic liquid crystal solution.

Therefore, in terms of polymer materials comprising aromatic compounds for preparation of compensation films, compensation of wavelength distribution should be in consideration since phase difference varies significantly according to wavelength. That is, even if compensation films comprising these materials compensate wavelength near 550 nm as they are optimally processed to obtain optical compensation with highest optical efficiency, they are not satisfactorily met requirements for optically compensating other wavelengths and may cause coloration problem. It is difficult to control the colors of displays due to this problem.

Based on these problems, the present invention provides an optical compensation film of PI film-comprising negative birefringent C plate, which is free of the above drawbacks of prior art and is useful as viewing angle compensation film for TFT-LCD, and a method of producing optical compensation film.

### SUMMARY OF THE INVENTION

The Present Inventors conducted extensive studies in order to find possible solutions for solving the above drawbacks of prior art. As a result, an optical compensation film comprising negative birefringent C plate with the following constitutes, and a method of producing optical compensation film are found to be capable to solve the above problems. Accordingly, the present invention is completed.

That is, the present invention provides:
(1) A method of producing optical compensation film comprising dissolving biphenyl ring structure without fluorine into a solvent to form a solution; applying the solution on a substrate; drying the solution through temperature-elevating process to form an optical compensation film comprising negative birefringent C plate with a thickness of 5 μm to 25 μm.
(2) The method of producing optical compensation film as described in the above (1), wherein the solvent is at least one compound selected from a group consisting of haloalkane compounds, aromatic compounds, cycloketo compounds, ether compounds, keto compounds, and mixtures thereof.
(3) The method of producing optical compensation film as described in the above (2), wherein the haloalkane compound is at least one compound selected from methylene chloride, dichloroethane, trichloroethane, and tetrachloroethane.
(4) The method of producing optical compensation film as described in the above (2), wherein the aromatic compound is toluene.
(5) The method of producing optical compensation film as described in the above (2), wherein the cycloketo compound is cyclopetanone or cyclohexanone.
(6) The method of producing optical compensation film as described in the above (2), wherein the ether compound is tetrahydrofuran (THF).
(7) The method of producing optical compensation film as described in the above (2), wherein the keto compound is at least one compound selected from acetone, methyl ethyl ketone (MEK), MIBK, MIPK, 1-methyl pyrrolidone (NMP), and dimethyl sulfoxide (DMSO).
(8) An optical compensation film of PI film-comprising negative birefringent C plate, which is made by the method of producing optical compensation film as described in the above (1).
(9) The optical compensation film as described in the above (8), which is usable as functional optical film for optoelectro panel displays.
(10)The optical compensation film as described in the above (8), which is applicable to STN, TN, IPS, VA, OCB, and ASM types of LCDs to enhance viewing angles.

### BRIEF DESCRIPTION OF THE DRAWINGS

FIG. 1 is a curve showing the relation between the thickness and Rth of the optical compensation film obtained in an embodiment according to the present method.

FIG. 2 is a curve showing the relation between the thickness and nx−nz of the optical compensation film obtained in an embodiment according to the present method.

### DESCRIPTION OF SYMBOLS

BBT aliphatic/biphenyl ring A without fluorine
BIBB aliphatic/biphenyl ring B without fluorine

### DETAILED DESCRIPTION OF THE INVENTION

According to the present invention, a PI optical compensation negative C plate of biphenyl ring structure without fluorine, and an optical compensation film of PI film-comprising negative birefringent C plate useful as TFT-LCD viewing angle compensation film, are obtained by a cost-efficient, easy-processed producing method by means of coating, instead of utilizing complicated steps of stretching and precisely controlling stretching ratio and direction in conventional technology.

The present optical compensation film of PI film-comprising negative birefringent C plate, and the method of producing optical compensation film, are described as following.

The method of producing optical compensation film according to the present invention comprises uniformly dissolving biphenyl ring structure PI without fluorine into a solvent in arbitrary ratio depending on desired properties; applying the solution on a substrate; drying through stepwise or continuous temperature-elevating process in an oven to form a film with a thickness of several μm to more than ten μm of which residual amount of solvent is less than 1%, wherein the film is an optical compensation film of negative birefringent C plate.

The solvent useful in the present invention is not particularly limited and is, for example, haloalkane compounds, aromatic compounds, cycloketo compounds, ether compounds, keto compounds, and mixtures thereof. It may be used alone or in combination of 2 or more.

The haloalkane compound useful in the present invention is not particularly limited and is, for example, methylene chloride, dichloroethane, trichloroethane, tetrachloroethane, and mixtures thereof. It may be used alone or in combination of 2 or more.

The aromatic compound useful in the present invention is not particularly limited and is, for example, toluene. The cycloketo compound useful in the present invention is not particularly limited and is, for example, cyclopetanone, cyclohexanone, and mixtures thereof. It may be used alone or in combination of 2 or more.

The ether compound useful in the present invention is not particularly limited and is, for example, tetrahydrofuran (THF). The keto compound useful in the present invention is not particularly limited and is, for example, acetone, methyl ethyl ketone (MEK), MIBK, MIPK, 1-methyl pyrrolidone (NMP), dimethyl sulfoxide (DMSO), and mixtures thereof. It may be used alone or in combination of 2 or more.

The method of producing optical compensation film according to the present invention, which comprises uniformly dissolving biphenyl ring structure PI without fluorine into the above-listed solvents in arbitrary ratio depending on desired properties; applying the solution on a substrate to form a film with a thickness of several μm to more than ten μm; then drying through stepwise or continuous temperature-elevating process in an oven so that the above-made wet film is dried to residual amount of solvent of less than 1%, produces a functional optical film applicable to optoelectro panel displays, particularly an optical compensation film of PI film-comprising negative birefringent C plate applicable to STN, TN, IPS, VA, OCB, and ASM types of LCDs to enhance viewing angles.

The coating method useful in the present invention is not particularly limited and may be any method which is capable to form uniform optical films, for example, roll coating, spin coating, doctor knife coating, etc., as long as it does not detract the scope of the present invention.

### EXAMPLES

The following illustrates the embodiments of the present invention, however, the present invention is not limited thereto. Also, the evaluations performed in the embodiments were conducted according to the following testing procedures and standards.

20% polyamide (PI) coatings were formulated by sufficiently agitating components showed in Table 1 dissolved in cyclopentanone at normal temperature, and the viscosities (25° C.) of the obtained 20% polyamide coatings were measured.

Then, the above-obtained 20% polyamide coatings were applied to glasses with doctor knives of different sizes in coating area of about 10×20 cm²; thereafter they were left standing in oven for 10 minutes to be dried by a continuous temperature-elevating process which was sequentially 80° C./30 min, 120° C./30 min, 160° C./30 min, and 200° C./12 hr; the dried polyamide films/glasses were put into water for 10 minutes; and the polyamide films and glasses were separated to obtain polyamide films.

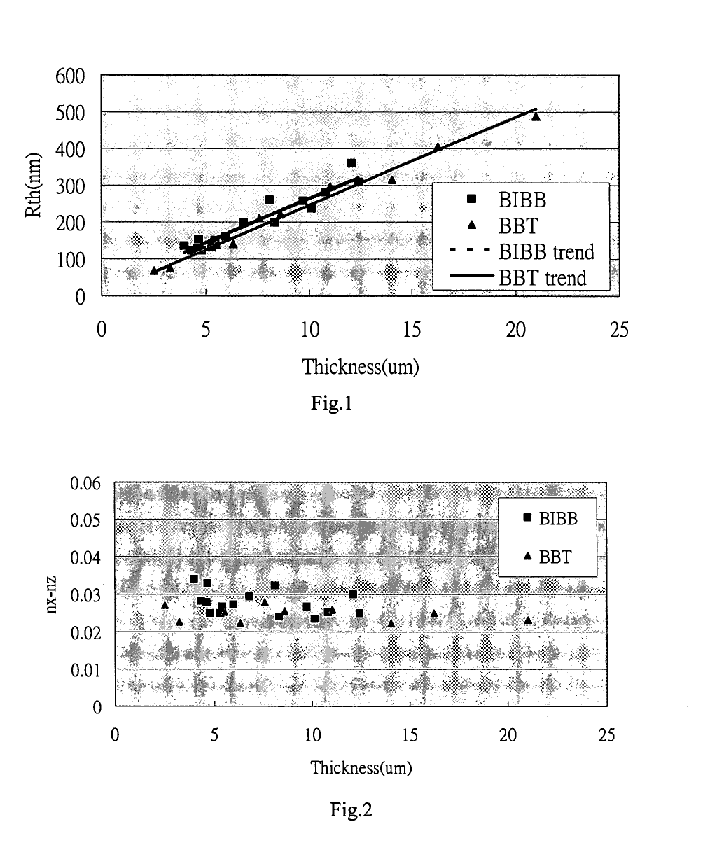

Then, the basic optical properties such as haze of the obtained polyamide films were evaluated by the following methods with instruments described herein. The results are showed in FIGS. 1 & 2, and Table 1.

<Refractometer>

Using DR-M2 refractometer with filter at wavelength of 589 nm, refractive index values of polyamide films at wavelength of 589 nm were measured.

<Haze Meter>

Using NDH 2000 haze meter, haze values of polyamide films (4×4 cm²) were measured, whereby blank calibration was conducted before polyamide films to be measured were mounted.

<Optical Thickness Meter>

Using optical thickness meter (ETA-STC), thickness values of polyamide films were measured based on light reflection principle by inputting refractive index values of polyamide films.

<Optical Birefringence Analyzer>

Using optical birefringence analyzer (KOBRA-21ADH), R0, Rth, coordinate angle, nx, ny, and nz were measured by firstly mounting a polyamide film having a size of 4×4 cm² on measuring position; inputting thickness of polyamide film and measuring polyamide film within angle range of −50° to 50° at interval of 10°; then inputting refractive index values of polyamide films.

<Spectrophotometer>

Using Hitachi U-4100 spectrophotometer, transmittance values of polyamide films at 550 nm visible were measured by firstly mounting a polyamide film having a size of 4×4 cm² on measuring position in spectrophotometer, and scanning through the range of 380 nm to 700 nm.

TABLE 1

| | | | | | | | Coordinate |
|---|---|---|---|---|---|---|---|
| | Thickness | R0 | Rth | HZ | TT | | angle |
| PI | μm | nm | nm | % | % | b | degree |
| BBT-1 | 2.53 | 0.3 | 67.7 | 0.54 | 89.11 | 0.67 | 28.7 |
| BBT-2 | 3.30 | 0.3 | 74.9 | 0.13 | 89.25 | 0.66 | −89.7 |
| BBT-3 | 5.51 | 0.4 | 138.7 | 0.52 | 88.82 | 1.07 | 81.8 |
| BBT-4 | 6.31 | 0.8 | 140.8 | 0.11 | 88.97 | 0.98 | 87.2 |
| BBT-5 | 7.58 | 0.4 | 210.6 | 1.07 | 88.83 | 1.38 | −79.9 |
| BBT-6 | 8.60 | 1.2 | 220.8 | 0.89 | 88.35 | 1.47 | 89 |
| BBT-7 | 11.01 | 1.9 | 296.9 | 0.24 | 88.9 | 1.15 | −89.8 |
| BBT-8 | 14.06 | 3.1 | 314.8 | 0.81 | 87.67 | 2.32 | −88.4 |
| BBT-9 | 16.28 | 1 | 405.3 | 0.44 | 88.57 | 1.7 | −14.9 |
| BBT-10 | 20.98 | 0.1 | 487.7 | 0.32 | 88.43 | 1.87 | −15 |
| BIBB-1 | 3.98 | 0.1 | 135.5 | 1.14 | 88.72 | 0.65 | 69.4 |
| BIBB-2 | 4.34 | 0.5 | 123 | 0.41 | 87.95 | 1.16 | 6.7 |
| BIBB-3 | 4.60 | 0.9 | 128.6 | 0.22 | 88.95 | 0.56 | −76 |
| BIBB-4 | 4.67 | 1 | 153.1 | 2.16 | 88.73 | 0.68 | 73.3 |
| BIBB-5 | 4.80 | 0.5 | 122.8 | 0.15 | 88.64 | 1.12 | −88.3 |
| BIBB-6 | 5.30 | 0.3 | 131.5 | 0.67 | 88.41 | 1.2 | 0 |
| BIBB-7 | 5.44 | 2.3 | 149.9 | 0.77 | 88.92 | 0.6 | −85.4 |
| BIBB-8 | 5.96 | 2.9 | 161.3 | 0.48 | 87.62 | 1.51 | −82.7 |
| BIBB-9 | 6.80 | 2 | 198.5 | 0.96 | 88.88 | 0.63 | −87.5 |
| BIBB-10 | 8.08 | 2.2 | 260.1 | 1.23 | 88.55 | 0.89 | −84.8 |
| BIBB-11 | 8.30 | 1.8 | 199 | 0.34 | 88.45 | 1.6 | 1.1 |
| BIBB-12 | 9.70 | 2.7 | 258 | 0.55 | 86.79 | 2.3 | 89.6 |
| BIBB-13 | 10.10 | 2.2 | 237 | 0.26 | 88.14 | 2.02 | −0.8 |
| BIBB-14 | 10.80 | 2.6 | 281.2 | 0.35 | 88.76 | 0.8 | 80.6 |
| BIBB-15 | 12.07 | 5.1 | 360.6 | 1 | 88.27 | 1.06 | 63.6 |
| BIBB-16 | 12.42 | 2.7 | 308.6 | 0.49 | 86.01 | 2.96 | 88.4 |

### INDUSTRY APPLICABILITY

According to the present invention, polyamide is uniformly dissolved into a solvent and is applied on glass or other substrates to form a film with a thickness of several μm to more than ten μm; thereby an optical compensative negative C plate of biphenyl ring structure polyamide without fluorine is prepared; and the film is useful as viewing angle compensation film for TFT-LCDs due to having optical compensation film of negative birefrigent C plate.

Further, according to the present invention, a PI optical compensation negative C plate of biphenyl ring structure without fluorine, and an optical compensation film of PI film-comprising negative birefringent C plate useful as viewing angle compensation film for TFT-LCD, STN, TN, IPS, VA, OCB, and ASM types of LCDs, are obtained by a cost-efficient, easy-processed producing method by means of coating, instead of utilizing complicated steps of stretching and precisely controlling stretching ratio and direction in conventional technology.

We claim:

1. A method of producing optical compensation film comprising dissolving biphenyl ring structure without fluorine into a solvent to form a solution; applying the solution on a substrate; drying the solution through temperature-elevating process to form an optical compensation film comprising negative birefringent C plate with a thickness of 5 μm to 25 μm.

2. The method of producing optical compensation film as described in claim 1, wherein biphenyl ring structure is polyamide (PI).

3. The method of producing optical compensation film as described in claim 1, wherein the solvent is at least one compound selected from a group consisting of haloalkane compounds, aromatic compounds, cycloketo compounds, ether compounds, keto compounds, and mixtures thereof.

4. The method of producing optical compensation film as described in claim 3, wherein the haloalkane compound is at least one compound selected from methylene chloride, dichloroethane, trichloroethane, and tetrachloroethane.

5. The method of producing optical compensation film as described in claim 3, wherein the aromatic compound is toluene.

6. The method of producing optical compensation film as described in claim 3, wherein the cycloketo compound is cyclopetanone or cyclohexanone.

7. The method of producing optical compensation film as described in claim 3, wherein the ether compound is tetrahydrofuran (THF).

8. The method of producing optical compensation film as described in claim 3, wherein the the keto compound is at least one compound selected from acetone, methyl ethyl ketone (MEK), MIBK, MIPK, 1-methyl pyrrolidone (NMP), and dimethyl sulfoxide (DMSO).

9. An optical compensation film of PI film-comprising negative birefringent C plate, which is made by the method of producing optical compensation film as described in claim 1.

10. The optical compensation film as described in claim 9, which is usable as functional optical film for optoelectro panel displays.

11. The optical compensation film as described in claim 9, which is applicable to STN, TN, IPS, VA, OCB, and ASM types of LCDs to enhance viewing angles.
